(19) United States
(12) Patent Application Publication
(10) Pub. No.: US 2015/0072603 A1
(43) Pub. Date: Mar. 12, 2015

(54) Controlled Atmosphere Workstation

(71) Applicant: Oxford Optronix Limited, Oxfordshire (GB)

(72) Inventors: William Neil Spencer, Merseyside (GB); Andrew Nadeem Obeid, Oxfordshire (GB); Michael Stanley Wright, Devon (GB)

(73) Assignee: Oxford Optronix Limited, Oxfordshire (GB)

(21) Appl. No.: 14/389,334

(22) PCT Filed: Mar. 21, 2013
(86) PCT No.: PCT/GB2013/050737

§ 371 Date: Sep. 29, 2014

(30) Foreign Application Priority Data
Mar. 30, 2012 (GB) 1205766.7

(51) Int. Cl. B08B 15/02

(52) U.S. Cl. CPC B08B 15/023
USPC 454/56

(57) ABSTRACT

A controlled atmosphere workstation comprising a transparent housing (1) having a pair of apertures (21, 22) through which can be inserted the hands of a user. The chamber has a forward part defined at least in part by a pair of opposed side wall portions (7, 10) which converge towards the front of the chamber, in which the apertures are provided. There is a font panel (3) and an upwardly inclined top viewing panel (13). The housing is mounted on a base (2) and contains a gas circulation system which directs filtered gas onto the side walls of the chamber on both sides, and then re-circulates the gas into a gas circulation chamber provided with fans (31, 32) on either side, feeding outlets (27, 28).

This invention relates to a controlled atmosphere workstation.

The invention is particularly, but not exclusively, concerned with a workstation for laboratory use in which the gas content of the atmosphere can be controlled—such as the nitrogen, and/or oxygen, and/or carbon dioxide content can be controlled. In addition or alternatively the temperature and/or the humidity can also be controlled. The invention is more particularly concerned with a workstation in which work can be done under hypoxic—i.e. depleted oxygen—conditions. A typical use of a workstation in accordance with the invention is in the field of the life-sciences in which the invention is capable of creating reproducible in vitro cell hypoxia environments which are deemed vital for the precise analysis of both cell metabolism and cell function.

There are various workstations available for carrying out tasks in a hypoxic environment, such as the Invivo₂™ from Ruskinn or the Hypoxystation™ from Don Whitley Scientific. These have a work chamber with a flat, forward facing glass panel, provided with apertures through which the hands and forearms of a user can be inserted into the chamber in sealing fashion using a cuff or the like. The chamber typically cuboid in shape and includes means for controlling the temperature and humidity within the chamber, and for circulating the desired gas mixture.

Viewed from one aspect the present invention provides a controlled atmosphere workstation comprising a work chamber having a pair of apertures through which can be inserted the hands of a user, at least part of the chamber being transparent; wherein the chamber has a forward part defined at least in part by a pair of opposed side wall portions which converge towards the front of the chamber, one of said apertures being provided in one of said side wall portions and the other of said apertures being provided in the other of said side wall portions.

The user would normally be located adjacent the forward part of the chamber.

The chamber could be defined by a curved wall, such as being part of a cylinder or another curved body. Such a curved wall would be convex about an upwardly extending axis, and the apertures would be spaced circumferentially. Alternatively there could be a pair of relatively flat side wall portions converging towards the user, in each of which one of the apertures is positioned. In either case the converging side wall portions may be interconnected by a front wall portion extending straight across the workstation, and this front wall portion may be relatively flat. The front wall portion may be a flat panel extending upwardly, for example extending substantially vertically. Preferably at least part of the front wall portion, and/or at least part of each side wall portion, is transparent to enable a user to see inside the chamber.

In a preferred embodiment an upright front wall is joined to an upper viewing panel, at least part of which is transparent. This upper viewing panel slopes upwardly and away from the front panel, for example at an angle of between 20 degrees and 40 degrees away from the vertical, such as at about 30 degrees. The upper viewing panel is preferably also joined to the upper edges of the converging side walls. In such an arrangement the side walls will have upper edges which incline upwardly away from the front of the chamber.

There may be an additional panel sealing the top of the chamber. The remainder of the chamber may, for example, take the form of a part-cylindrical body.

In one preferred embodiment the chamber is defined by a body which has the following surfaces: (i) a vertically extending front panel having a top edge and two side edges; (ii) a left hand side panel which extends away from the front panel and has a front edge joined to one side edge of the front panel, and an upper edge which extends at an angle upwardly and away from the front panel; (iii) a right hand side panel which extends away from the front panel and has a front edge joined to the other side edge of the front panel, and an upper edge which extends at an angle upwardly and away from the front panel; and (iv) an upper viewing panel which is inclined upwardly and away from the front panel and has a lower edge connected to the top edge of the front panel, a left side edge connected to the upper edge of the left hand side panel, and a right side edge connected to the upper edge of the right hand side panel.

One or more additional panels, such as a top panel, may be provided to close the chamber.

The body may be generally cylindrical in form, but modified to provide the above arrangement of panels.

The inclined upper viewing panel makes it easier for a viewer to see what is happening in the chamber, when working on a sample.

The apertures in the side panels may be provided with cuffs or the like to seal around the forearms of a user. There may be versions adapted for bare handed, gloved or gauntlet use. There may be closures such as plungers or the like sealing the apertures when not in use, and these may be displaced into the chamber when in use. There may be, for example, a storage shelf or the like inside the chamber on which the closures can be positioned.

The front panel may incorporate a letter box or similar arrangement so that sample can be introduced into and removed from the chamber

Adjacent the front of the chamber, for example below the front panel, there may be a panel to display information such as gas composition, humidity and temperature. This may be a touch sensitive panel so that controls can be operated and settings changed.

The chamber may have a base on which a work surface is provided and underneath which various components can be positioned. The display panel may be provided on the base. The upper part of the chamber comprising the side, front and other panels referred to may be a single housing unit that can be removed in one piece for cleaning or maintenance. At least this housing unit may, for example, be made principally of a transparent plastics material.

The above features of embodiments of the invention provide for more convenient manipulation by a user, as compared to the apertures simply being in a flat front panel. They also provide easier viewing by a user of what is being done within the chamber.

Another feature of embodiments of the invention concerns improving the flow of gases, such as depleted oxygen air, in the chamber. In such embodiments, within the chamber there is a gas circulation system comprising a first outlet which directs gas towards the rear of one of said side wall portions so as to flow towards the front of the chamber; a second outlet which directs gas towards the rear of the other of said side wall portions so as to flow towards the front of the chamber; and at least one inlet positioned towards the rear of the chamber, between the first and second outlets.

Thus the flow of gas, such as depleted oxygen air, follows paths which go from the outlets to the at least one inlet. At least one path on each side will tend to follow the converging wall of the chamber, before turning back towards the inlet. This can be advantageous in the case of procedures carried out at relatively high humidity, where condensation could form on the inside of the chamber wall. By urging the flow along the wall, the condensation can be removed or prevented.

In some embodiments, baffles can be used adjacent the outlets so as to direct more gas towards the wall of the chamber.

The outlets and the or each inlet may be connected to a distribution chamber to which the gas is fed from the main camber and is then pumped out through the outlets. The distribution chamber can serve to treat the gas. For example, the gas can be heated by heating elements or a heat exchanger, and/or the humidity controlled by a nebuliser, for example. Filters can be provided, such as High Efficiency Particulate Air filters. These may be provided at the or each inlet or at the outlets.

In the case of a filter at the inlet, this could be provided with a fan either upstream or downstream of the filter. An upstream inlet fan urges gas out of the main chamber, through the inlet filter and into the treatment chamber. A downstream inlet fan sucks gas from the main chamber through the inlet filter, and into the treatment chamber. In the case of filters at the outlets, gas would pass from the distribution chamber, through these and into the main chamber.

Whether or not there is fan pulling or pushing gas into the chamber adjacent the inlet, and whether or not there are outlet filters, in preferred embodiments there are fans adjacent each outlet. These can serve to direct gas tangentially onto the respective side wall portions, so as to encourage flow of gas around the walls.

In a preferred embodiment there is provided a gas distribution module comprising a gas distribution chamber, a first upwardly extending elongate outlet connected to the gas distribution chamber for directing gas towards one side of the main chamber, a second upwardly extending elongate outlet connected to the gas distribution chamber for directing gas towards the other side of the main chamber, and at least one inlet, positioned between the two outlets, connected to the gas distribution chamber for receiving recycled gas from the main chamber.

Preferably, with elongate outlets the associated fans are also elongate and each has elongate rotor blades which rotate about an upwardly extending axis.

A light may be provided in the main chamber, such as a central tube light or LED array or the like, and/or spotlights positioned where considered appropriate. Such a light or lights can be mounted on the gas distribution module. A shelf may also be provided in the main chamber, mounted on the gas distribution chamber.

The base of the main chamber may be provided with an aperture through which can pass the leads of a sensor, such as an oxygen concentration sensor, a carbon dioxide sensor, a temperature sensor and a humidity sensor which is to be used in the chamber.

These features of embodiments of the invention which are concerned with improving the flow of air through the chamber, are inventive in their own right and thus, viewed from another aspect the invention provides a controlled atmosphere workstation comprising a work chamber having a pair of apertures through which can be inserted the hands of a user, at least part of the chamber being transparent; wherein the chamber has a forward part defined at least in part by a pair of opposed side wall portions which converge towards the front of the chamber, and within the chamber there is a gas distribution system comprising a first outlet which directs gas towards the rear of one of said side wall portions so as to flow towards the front of the chamber; a second outlet which directs gas towards the rear of the other of said side wall portions so as to flow towards the front of the chamber; and at least one inlet positioned towards the rear of the chamber, between the first and second outlets.

The features described above in relation to embodiments of the first aspect of the invention concerning improving the flow of air through the chamber, are applicable also to this aspect of the invention. In addition, in certain embodiments of this aspect of the invention, one of said apertures through which can be inserted the hands of a user is provided in one of said converging side wall portions and the other of said apertures is provided in the other of said converging side wall portions. The user would normally be located adjacent the forward part of the chamber.

The invention may also be viewed from another aspects. For example viewed from another aspect the invention provides a controlled environment workstation comprising a chamber of generally circular or oval cross section about an upwardly extending axis, the chamber having at least one transparent viewing portion. The chamber may be generally cylindrical about an upwardly extending axis. The chamber may have a generally flat top. The chamber may have a forwards facing viewing portion. The chamber may have a viewing portion in the form of a transparent front panel which is inclined inwardly and upwardly. Where the chamber has a generally flat top, the transparent may be inclined upwardly and inwardly to adjacent the generally flat top.

Viewed from another aspect, the invention provides a controlled environment workstation which is cylindrical and has a flat top. Viewed from another aspect, the invention provides a controlled environment workstation which is cylindrical and has a sloping viewing panel. Viewed from another aspect, the invention provides a controlled environment workstation which is cylindrical and has a flat top and a sloping front.

An embodiment of aspects of the invention will now be described by way of example and with reference to the accompanying drawings, in which:

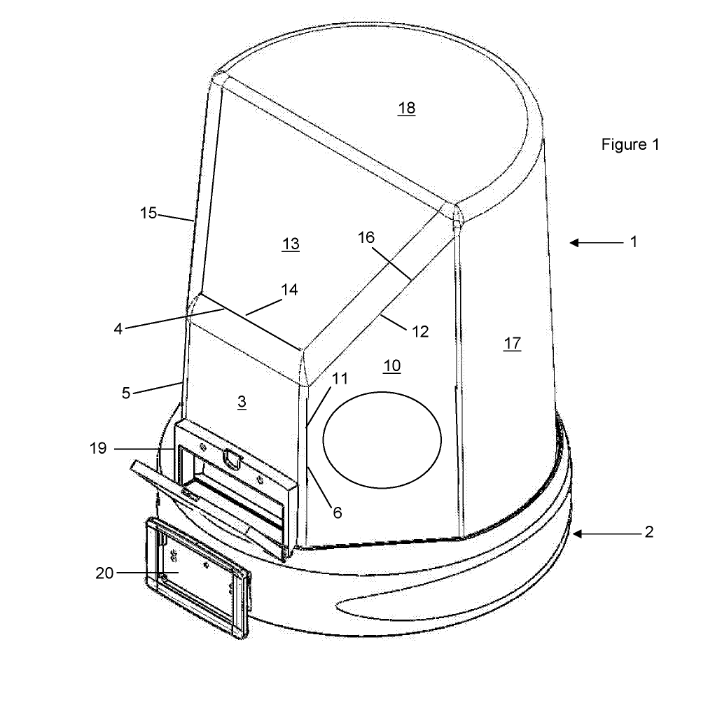

FIG. 1 is a perspective view of a controlled atmosphere workstation in accordance with the invention:

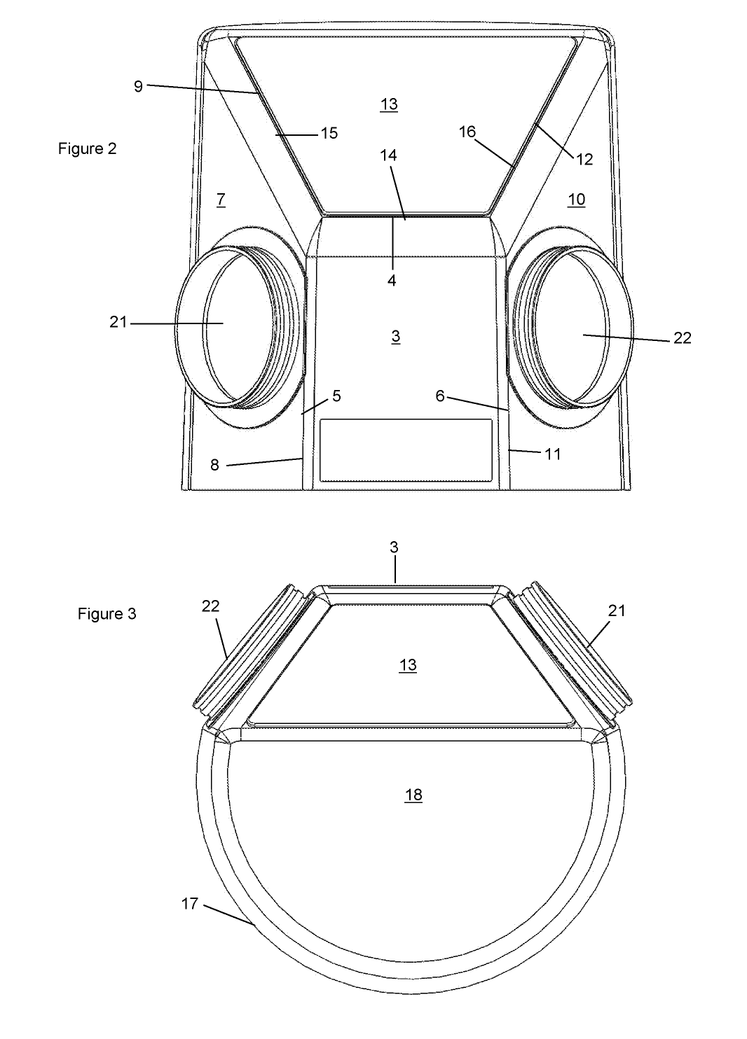

FIG. 2 is a front view of the housing of the workstation;

FIG. 3 is a top view of the housing of the workstation;

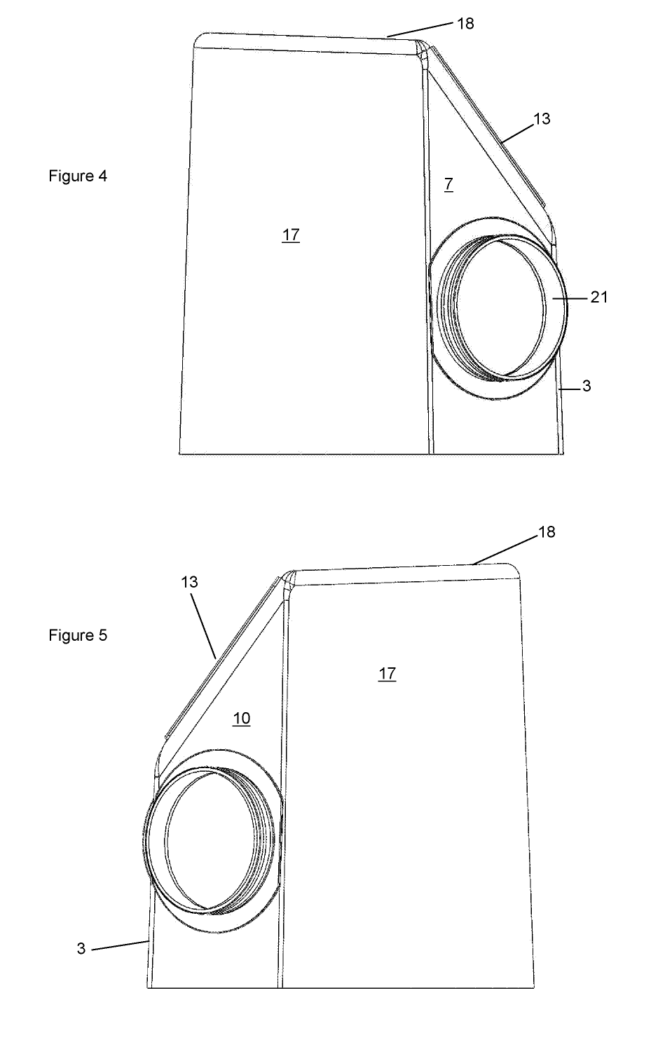

FIG. 4 is a left side view of the housing;

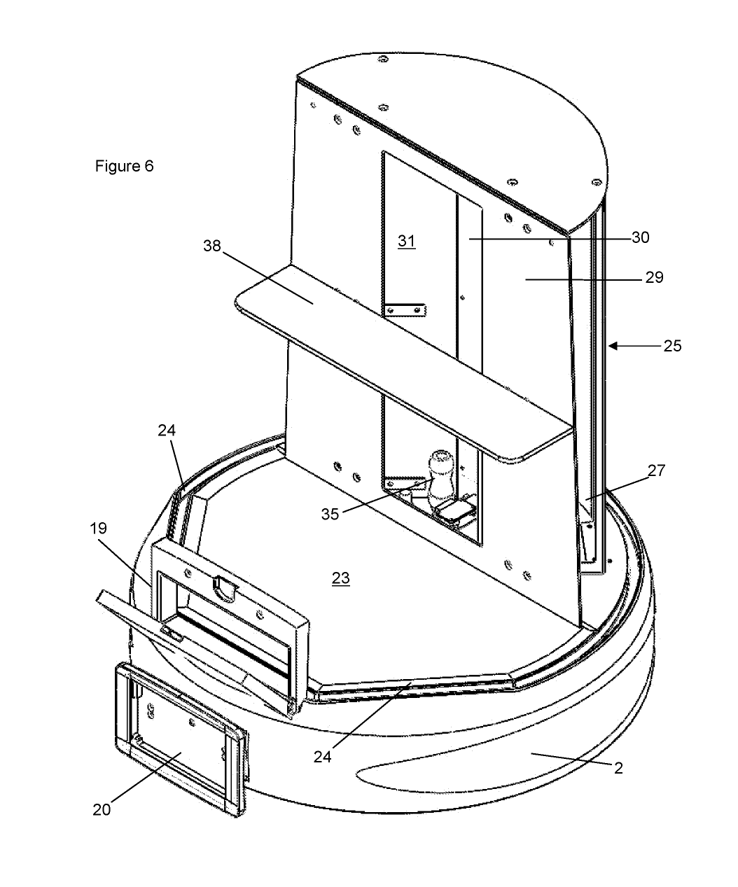

FIG. 5 is a right side view of the housing;

FIG. 6 is a perspective view of the workstation with the housing removed;

FIG. 7 is a top plan view of the workstation with the housing removed; and

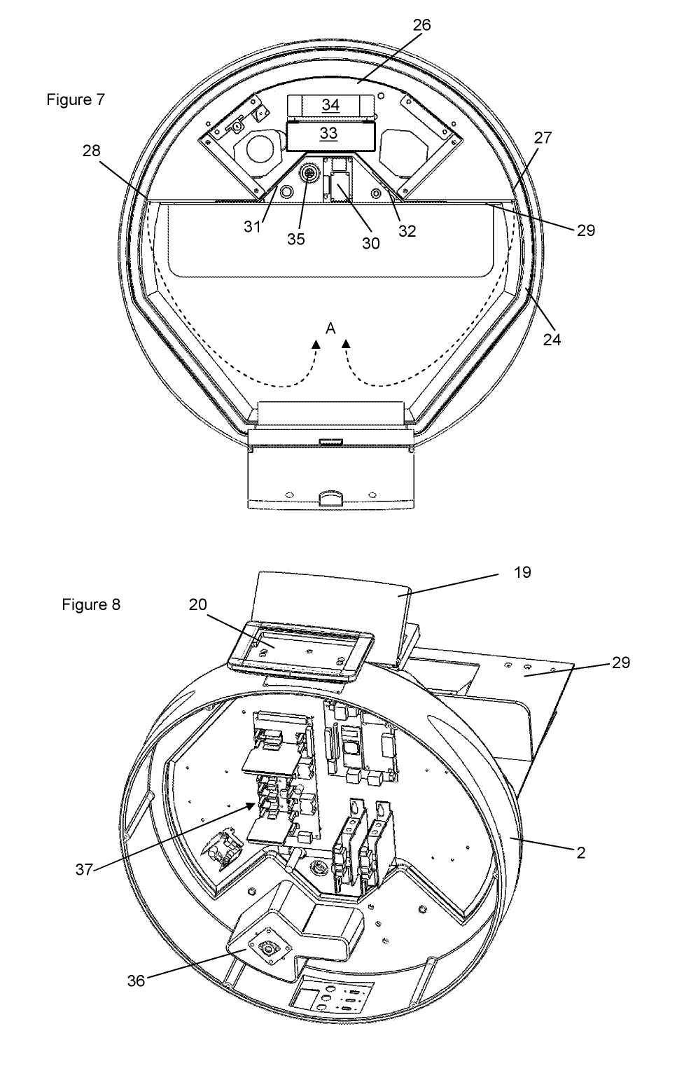

FIG. 8 is a perspective view from below of the workstation with the housing removed;

With reference to FIGS. 1 to 5, the workstation has a chamber defining portion in the form of a housing 1 of clear plastics material which is mounted on a base 2. The housing 1 is generally cylindrical but is modified to have the following surfaces: (i) a vertically extending front panel 3 having a top edge 4 and two side edges 5, 6; (ii) a left hand side panel 7 which extends away from the front panel 3 and has a front edge 8 joined to one side edge 5 of the front panel, and an upper edge 9 which extends at an angle upwardly and away from the front panel; (iii) a right hand side panel 10 which extends away from the front panel and has a front edge 11 joined to the other side edge 6 of the front panel, and an upper edge 12 which extends at an angle upwardly and away from the front panel; and (iv) an upper viewing panel 13 which is inclined upwardly and away from the front panel 3 and has a lower edge 14 connected to the top edge 4 of the front panel, a left side edge 15 connected to the upper edge 9 of the left hand side panel, and a right side edge 16 connected to the upper edge 12 of the right hand side panel. The remaining side wall portion 17 of the housing, interconnecting the left and right side panels, is curved, for example being part cylindrical. There is also a top 18 for the housing 1.

The housing 1 is releasably attached to a base 2 in a sealed manner so as to be airtight and to form a chamber.

Below the front panel 3 is a letter box arrangement 19 for introducing items into the chamber and removing them, from the chamber.

On the front of the base 2 is a touch sensitive display panel 20.

On side portions 7 and 10 of the housing, which converge towards the front of the workstation, there are apertures 21 and 22 respectively, each of which will contain a sealing cuff arrangement (not shown) so that a hand can be inserted into the chamber in an airtight fashion. The chamber may be provided with a bleed valve so that excess pressure created when a hand is inserted, can be relieved.

The base 2 is shown in more detail in FIGS. 6 to 8.

A top surface 23 of a forward portion the base 2, which will be inside the housing 1, provides a surface on which a user can place items. A seal 24 around the upper periphery of the base will form a seal with the housing 1 when positioned on the base, to form a sealed chamber.

Towards the rear of the base 2, there is a gas distribution and treatment module 25 described in more detail below. This defines a gas distribution chamber 26, with upwardly elongate gas outlets 27 and 28 directing gas at the curved side wall portion 17 of the housing, on either side of the housing. There is a front panel 29 which extends upwardly and which terminates short of the wall portion 17 on either side, so as to define the outlets 27 and 28. In this front panel 29 is defined an inlet 30 for gas to be re-circulated from the main chamber defined by the housing 1 and base 2, and into the gas distribution chamber 26. There are converging walls 31 and 32 which lead to a fan unit 33 and a filter 34, which filters the gas passing into the gas distribution chamber 26.

To urge the gas out of the distribution chamber 26 and through the outlets 27 and 28, there is an elongate, upwardly extending fan on each side of the distribution chamber which direct gas tangentially on to the opposite internal wall of the portion 17 of the housing 1. There is created, on both side of the housing, a flow of gas around the walls of the housing which then pass back to the inlet 30, as indicated by the arrows A on FIG. 7.

An outlet 35 is joined to a nebuliser unit 36 beneath the surface 23 of the base unit, which is used for controlling the humidity of the gas. Also beneath the base 23 is circuitry 37 for controlling the various functions of the workstation. There may also be one or more probes for measuring parameters such as temperature, humidity, carbon dioxide concentration and oxygen concentration.

A shelf 38 is provided on the front panel 29 of the gas treatment and distribution module, on which a user can place items. One or more lights can also be positioned on this font panel.

This embodiment provides a filtration system which protects samples such as cells from the risk of contamination. Precision concentrations of oxygen and carbon dioxide can be obtained using sophisticated gas flow controllers and auto-calibrating sensors providing electronic feedback. Climatic conditions are maintained using microprocessor controlled temperature and nebuliser based humidifier technology. Oxygen and carbon dioxide can be cycled rapidly.

The ergonomic design of the workstation ensures natural relaxed operation with the positions of the hand apertures. The angled upper viewing panel, particularly when combined with adjustable LED illumination, provides good visibility. The touch screen displays real time data and setting parameters in both digital and graphical format. A data port, such as a LAN connector, allows recording, storage and off-line data analysis.

The design minimises dead space to ensure frugal levels of gas usage.

There is thus provided a controlled atmosphere workstation comprising a transparent housing having a pair of apertures through which can be inserted the hands of a user. The chamber has a forward part defined at least in part by a pair of opposed side wall portions which converge towards the front of the chamber, in which the apertures are provided. There is a front panel and an upwardly inclined top viewing panel. The housing is mounted on a base and contains a gas circulation system which directs filtered gas onto the side walls of the chamber on both sides, the gas then being re-circulated through an inlet into a gas circulation chamber towards the rear of the workstation, provided with fans on either side.

1. A controlled atmosphere workstation comprising a work chamber having a pair of apertures through which can be inserted the hands of a user, at least part of the chamber being transparent; wherein the chamber has a forward part defined at least in part by a pair of opposed side wall portions which converge towards the front of the chamber, one of said apertures being provided in one of said side wall portions and the other of said apertures being provided in the other of said side wall portions; wherein within the chamber there is a gas circulation system comprising a first outlet which directs gas towards the rear of one of said side wall portions so as to flow towards the front of the chamber; a second outlet which directs gas towards the rear of the other of said side wall portions so as to flow towards the front of the chamber; and an inlet positioned towards the rear of the chamber, between the first and second outlets.

2-12. (canceled)

13. A controlled atmosphere workstation comprising a work chamber having a pair of apertures through which can be inserted the hands of a user, at least part of the chamber being transparent; wherein the chamber has a forward part defined at least in part by a pair of opposed side wall portions which converge towards the front of the chamber, one of said apertures being provided in one of said side wall portions and the other of said apertures being provided in the other of said side wall portions as claimed in claim 1, wherein the chamber is defined by a body which has the following surfaces: (i) a vertically extending front panel having a top edge and two side edges; (ii) a left hand side panel, which forms one of said side wall portions, and which extends away from the front panel and has a front edge joined to one side edge of the front panel, and an upper edge which extends at an angle upwardly and away from the front panel; (iii) a right hand side panel, which forms the other of said side wall portions, and which extends away from the front panel and has a front edge joined to the other side edge of the front panel, and an upper edge which extends at an angle upwardly and away from the front panel; (iv) a curved rear wall interconnecting the left and right side panels; and (v) an upper viewing panel which is inclined upwardly and away from the front panel and has a lower edge connected to the top edge of the front panel, a left side edge connected to the upper edge of the left hand side panel, and a right side edge connected to the upper edge of the right hand side panel.

14. A workstation as claimed in claim 13, wherein at least part of each side panel is transparent to enable a user to see inside the chamber.

15. A workstation as claimed in claim 13, wherein at least part of the front panel is transparent to enable a user to see inside the chamber.

16. A workstation as claimed in claim 13, wherein at least part of the upper viewing panel is transparent to enable a user to see inside the chamber.

17. (canceled)

18. A workstation as claimed in claim 1, wherein baffles are used adjacent the outlets so as to direct more gas towards the side wall portions of the chamber.

19. A workstation as claimed in claim 1, wherein a fan is provided adjacent each outlet.

20. A workstation as claimed in claim 1, wherein the outlets and the inlet are connected to a gas distribution chamber where the gas can be heated and/or subject to humidity control, and/or filtered.

21. A workstation as claimed in claim 1, wherein a filter is provided adjacent the inlet.

22. A workstation as claimed in claim 1, wherein a fan is provided adjacent the inlet.

23. A workstation as claimed in claim 1, wherein a filter is provided adjacent each outlet.

24. A workstation as claimed in claim 1, wherein there is provided a gas treatment module comprising a panel defining a region behind the panel, a first upwardly extending elongate outlet connected to the region for directing gas towards one side of the main chamber, a second upwardly extending elongate outlet connected to the region for directing gas towards the other side of the main chamber, and there being an aperture in the panel for gas to pass into the region.

25. A controlled atmosphere workstation comprising a work chamber having a pair of apertures through which can be inserted the hands of a user, at least part of the chamber being transparent; wherein the chamber has a forward part defined at least in part by a pair of opposed side wall portions which converge towards the front of the chamber, and within the chamber there is a gas distribution system comprising a first outlet which directs gas towards the rear of one of said side wall portions so as to flow towards the front of the chamber; a second outlet which directs gas towards the rear of the other of said side wall portions so as to flow towards the front of the chamber; and at least one inlet positioned towards the rear of the chamber, between the first and second outlets.

26-33. (canceled)

34. A controlled atmosphere workstation as claimed in claim 13, wherein within the chamber there is a gas circulation system comprising a first outlet which directs gas towards the rear of one of said side wall portions so as to flow towards the front of the chamber; a second outlet which directs gas towards the rear of the other of said side wall portions so as to flow towards the front of the chamber; and an inlet positioned towards the rear of the chamber, between the first and second outlets.

35. A controlled atmosphere workstation comprising a work chamber having a pair of apertures through which can be inserted the hands of a user, at least part of the work chamber being transparent; wherein the work chamber has left and right side walls, a forward part of the work chamber being defined at least in part by a portion of the left side wall and an opposed portion of the right side wall, the opposed side wall portions converging towards the front of the work chamber, one of said apertures being provided in one of said side wall portions and the other of said apertures being provided in the other of said side wall portions; wherein within the work chamber there is provided a panel towards the rear of the work chamber, behind which is defined a gas distribution chamber; there being a gas inlet into gas distribution chamber from the work chamber, and a recirculation system which circulates gas from the gas distribution chamber, into the work chamber and back into the gas distribution chamber;
wherein there is a first gas outlet from the gas distribution chamber into the work chamber which is positioned on the left of the gas distribution chamber and which directs gas towards the rear of said portion of the left side wall of the work chamber so as to flow towards the front of the work chamber; and there is a second gas outlet from the gas distribution chamber into the work chamber which is positioned on the right of the gas distribution chamber and which directs gas towards the rear of said portion of the right side wall of the work chamber, so as to flow towards the front of the work chamber; and in that the gas inlet into the gas distribution chamber is positioned towards the rear of the work chamber, between the first and second gas outlets.

36. A workstation as claimed in claim 35, wherein the panel extends upwardly and terminates short of the left side wall and the right side wall, so that the first gas outlet from the gas distribution chamber into the work chamber is defined between the panel and the left side wall and is in the form of a first upwardly extending elongate outlet; and the second gas outlet from the gas distribution chamber into the work chamber is defined between the panel and the right side wall is in the form of a second upwardly extending elongate outlet.

37. A workstation as claimed in claim 36, wherein the recirculation system comprises a fan adjacent each of the first and second gas outlets, the first gas outlet being provided with an elongate, upwardly extending fan which directs gas tangentially on to the left side wall, and the second gas outlet being provided with an elongate, upwardly extending fan which directs gas tangentially on to the right side wall.

38. A workstation as claimed in claim 35, wherein the gas inlet into the gas distribution chamber is provided by an aperture in the panel.
